(19) United States
(12) Patent Application Publication
(10) Pub. No.: US 2026/0048631 A1
(43) Pub. Date: Feb. 19, 2026

(54) UNMANNED TRANSPORT VEHICLE WITH IMPROVED ANTI-TIPPING PERFORMANCES

(71) Applicant: ABB SCHWEIZ AG, Baden (CH)

(72) Inventors: Zhijun Ding, Shanghai (CN); Pushuang Xu, Shanghai (CN); Zhenghao Dong, Shanghai (CN)

(21) Appl. No.: 19/370,213

(22) Filed: Oct. 27, 2025

Related U.S. Application Data
(63) Continuation of application No. PCT/CN2023/092003, filed on May 4, 2023.

(51) Int. Cl. B60G 5/02; B60G 7/00; B60G 7/02; B60L 15/20; B62D 61/10

(52) U.S. Cl. CPC B60G 5/02; B60G 7/001; B60G 7/008; B60G 7/02; B60L 15/20; B62D 61/10; B60G 2204/143; B60G 2204/41; B60G 2300/38; B60G 2300/50

(57) ABSTRACT

Embodiments of the present disclosure relate to an unmanned transport vehicle with improved anti-tipping performances. The unmanned transport vehicle includes a chassis and a suspension device configured to connect the chassis to a wheel and allow a relative motion between the chassis and the wheel. The suspension device includes a first wheel a second wheel a support bracket connecting the first wheel and the second wheel and a hinge shaft configured to connect the support bracket to the chassis wherein a first sensor is provided on the hinge shaft to detect a force transmitted from the chassis to the support bracket.

### FIELD

Embodiments of the present disclosure generally relate to a field of an unmanned transport vehicle, and more specifically, to an unmanned transport vehicle with improved anti-tipping design.

### BACKGROUND

Unmanned transport vehicles are widely used in an industrial filed and are used to automatically transport articles (such as containers) and the like without intervention of human. An AGV (Automatic Guided Vehicle) is one typical form of unmanned transport vehicles with automatic guidance devices, such as electromagnetic or optical components and is designed to travel along a designated path. AGVs are superior to conventional manned transport vehicles, such as trucks, in terms of costs, efficiencies, automation levels and unified coordination and are playing a greater and greater role in automated transportation.

The AGV is typically equipped with various safety protection devices to ensure that the AGV can work properly. One of the safety protection devices is an anti-tipping device which is designed to detect a gravity of the payload and to prevent the AGV from tipping based on the detected gravity. During operation of the AGV, when large loads are placed on the AGV, there is a high possibility that the AGV tends to deviate from or slide off the designed path due to acceleration and deceleration of the AGV, which is dangerous or is not desired. When ground surface of the industrial field is rough, the uneven ground surface makes this situation worse. For example, the Chinese Patent publication CN207133011U, CN217111306U discloses various weighing devices which are to detect a payload on the AGV. These conventional devices, however, are not satisfactory in terms of performances and there is still a need to further improve the anti-tipping performances of the AGV.

### SUMMARY

Example embodiments of the present disclosure provide an unmanned transport vehicle which is designed with improved anti-tipping performances.

In a first aspect of the present disclosure, there is provided an unmanned transport vehicle. The unmanned transport vehicle comprises a chassis and a suspension device configured to connect the chassis to a wheel and allow a relative motion between the chassis and the wheel, the suspension device comprising a first wheel, a second wheel, a support bracket connecting the first wheel and the second wheel, and a hinge shaft configured to connect the support bracket to the chassis, wherein a first sensor is provided on the hinge shaft to detect a force transmitted from the chassis to the support bracket. With this arrangement, the sensor arrangement does not affect overall height of the vehicle. Moreover, the sensor can detect the overall weight of the vehicle which is beneficial in terms of improving anti-tipping performances.

In some embodiments, the first sensor may be integrated in the hinge shaft. With this arraignment, the sensor arrangement can be easily implemented in the hinge shaft without increasing the cost for the vehicle.

In some embodiments, the hinge shaft may be kept in a predetermined orientation with respect to the chassis and the support bracket. With this arrangement, it is possible to ensure that the sensor is at a predetermined orientation proper for measurement.

In some embodiments, the hinge shaft may comprise a first stem portion, a second stem portion extending in an axial direction of the hinge shaft, and a wiring interface arranged on one axial end of the hinge shaft. With the stem portions, the hinge shaft can reliably contact the chassis and the support bracket. With the wiring interface, the signal form the sensor can be output easily.

In some embodiments, the hinge shaft may comprise a location hole extending in a direction perpendicular to an axial direction of the hinge shaft and configured to receive a member or a protrusion of the chassis to lock the hinge shaft in place. With this arrangement, the hinge shaft can be prevented from rotating. Also, the hinge shaft can be fixed in position.

In some embodiments, the support bracket may comprise a first end section configured to receive the first wheel, a second end section opposite to the first end section and configured to receive the second wheel, and an intermediate section configured to connect the first end section and the second end section, the intermediate section comprising a through hole for insertion of the hinge shaft.

In some embodiments, the suspension device may further comprise a bushing sandwiched between an inner wall of the through hole and an outer surface of the hinge shaft. With this arrangement, a movement pair between the hinge shaft and the support bracket can be well protected.

the hinge shaft can be well protected.

In some embodiments, the suspension device may further comprise a spacer arranged around the hinge shaft and sandwiched between a lateral side surface of the chassis and a lateral side surface of the support bracket. With this arrangement, a movement pair between the chassis and the support bracket can be well protected.

In some embodiments, the hinge shaft may further comprise a circumferential groove configured to receive the spacer. With this arrangement, the circumferential groove can locate the spacer.

In some embodiments, the first wheel may be a driving wheel actuated by an electronical actuator, and the second wheel may be a caster wheel. In some embodiments, both the first wheel and the second wheel may be caster wheels.

In some embodiments, the unmanned transport vehicle may further comprise a second suspension device laterally arranged side by side with respect to the suspension device, the second suspension device comprising a third wheel, a fourth wheel, a second support bracket connecting the third wheel and the fourth wheel, and a second hinge shaft configured to connect the second support bracket to the chassis, wherein a second sensor is provided on the second hinge shaft to detect a force transmitted from the chassis to the second support bracket.

In some embodiments, the unmanned transport vehicle may further comprise a third suspension device arranged at a front side or a back side with respect to the suspension device in a travel direction of the unmanned transport vehicle, the third suspension device comprising a fifth wheel and a sixth wheel, a third support bracket connecting the fifth wheel and the sixth wheel, and a third hinge shaft configured to connect the third support bracket to the chassis, wherein a third sensor is provided on the third hinge shaft to detect a force transmitted from the chassis to the third support bracket.

In a second aspect of the present disclosure, there is provided a system for driving an unmanned transport vehicle. The system comprises a hinge shaft configured to connect a support bracket supporting a wheel to a chassis and comprising a sensor configured to detect a force transmitted from the chassis to the support bracket, and a controller configured to communicate with the sensor and to control a electronical actuator for driving a driving wheel based on the detected force.

It would be appreciated that this summary is not intended to identify key features or essential features of embodiments of the present disclosure, nor is it intended to be used to limit the scope of the present disclosure. Other features of the present disclosure will become evident through the following description.

### BRIEF DESCRIPTION OF THE DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 is a schematic overall perspective view of an unmanned transport vehicle according to one example embodiment of the present disclosure;

FIG. 2 is a perspective view of the unmanned transport vehicle shown in FIG. 1, with a support platform being removed;

FIG. 3 is a bottom view of an unmanned transport vehicle according to one example embodiment of the present disclosure;

FIG. 4 is a perspective view of a suspension device including a driving wheel according to one example embodiment of the present disclosure;

FIG. 5 is a perspective view of a suspension device including two driven wheels according to one example embodiment of the present disclosure;

FIG. 6 is an exposed view of the suspension device of FIG. 4;

FIG. 7 is a perspective view of a hinge shaft according to one example embodiment of the present disclosure; and

FIG. 8 is a partial section view through a mounting portion in FIGS. 1 and 2 according to one example embodiment of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

According to the present disclosure, for sake of description, a AGV is shown and taken as an example of an unmanned transport vehicle. It is to be understood that the inventive concept of the present disclosure is also applicable to other unmanned autonomous mobile vehicle, such as automatic mobile robots, mobile hybrid robots and the like.

As mentioned above, unmanned transport vehicles, such as AGVs, are widely used for automatically transport articles. When articles (also called payloads) are loaded on the unmanned transport vehicles, there is a high risk that the vehicle would overturn, or deviate from the designed track (if the unmanned transport vehicle is an AGV) due to inertia of the articles during acceleration and deceleration of the vehicle. When the travelling ground is uneven, this problem becomes worse. To deal with this technical problem, conventional unmanned transport vehicles are provided with a weighing system including one or more sensors provided on a lift platform for supporting the articles. When the articles are placed on the lift platform, the sensors detect the weight of the articles and the weight data of the articles can be used to control driving of the vehicle.

This conventional arrangement is subject to the following disadvantages. One of the disadvantages is that configuration of the sensor arrangements is complicated and should be specifically mounted at the lift platform. Besides assembly complexity and the associated high costs, these sensors are vertically arranged and thus adversely increase the overall height of the lift platform, which may further increase the risk of overturning of the vehicle. There is a need to further reduce the total height of the vehicle. Another disadvantage is that the sensor arrangement merely detects the weight of the payload rather than the weight of the whole vehicle. Due to the fact that whether the vehicle overturns or not is determined by a gravity displacement of the overall weight of the vehicle (i.e., the weight of the articles plus the weight of the vehicle itself), there is still a possibility of overturning using this conventional measure since the above sensor arrangement ignores weights of the vehicle itself including weights of the chassis, drive train for driving the wheels, and the like. Thus, there is a need to further improve accuracy for determining gravity displacement of the vehicle. According to the present disclosure, there is provided a novel sensor arrangement arranged in a suspension device of the unmanned transport. With this arrangement, one or more above technical problems can be solved.

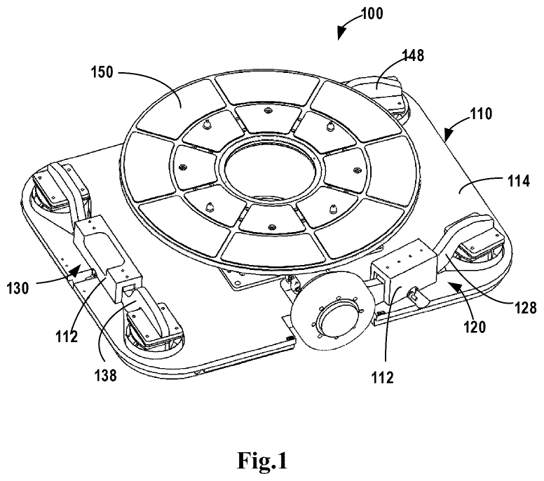

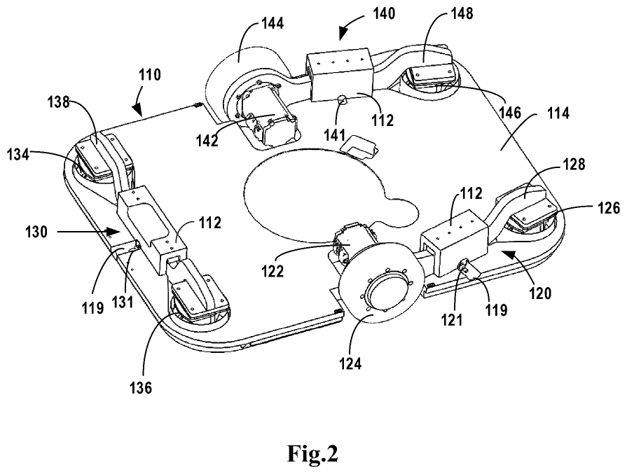

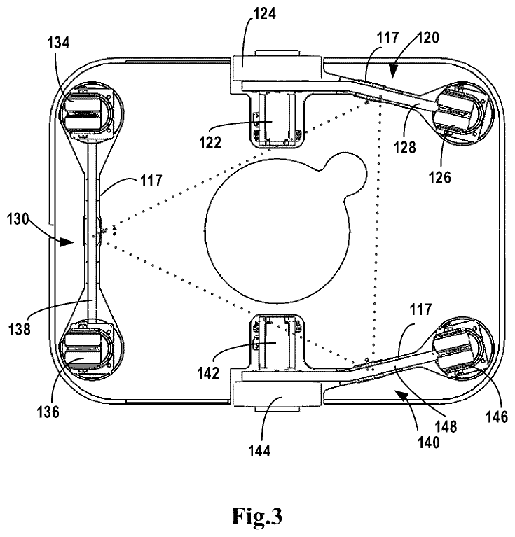

FIGS. 1-3 show different schematic views of an unmanned transport vehicle according to one example embodiment of the present disclosure as viewed from different perspectives. FIG. 1 is a schematic overall perspective view of the unmanned transport vehicle 100. FIG. 2 is analogous to FIG. 1 but with a support platform and some other unessential components removed to better show components related to the inventive concept of the present disclosure. FIG. 3 is a bottom view of the unmanned transport vehicle showing structural details of bottom side of a chassis and exemplary spatial arrangement of suspense devices.

As shown in FIGS. 1 and 2, an unmanned transport vehicle 100 includes a chassis 110, a support platform 150 arranged on the chassis 110, and one or more wheels 124, 126, 134, 136, 144, and 146. The chassis 110 is a rigid frame and is configured to support all loads applied on the vehicle. Components for driving the wheels and other functional components may also be fixed on the chassis. In the shown embodiment, the chassis 110 is in a form of a plate. The chassis 110 includes a body 114 which is configured to carry the support platform 150. It is to be understood that this is merely illustrative and the chassis 110 may be of any other proper forms. The support platform 150 is configured to support the loads (such as articles). In the shown embodiment, the support platform 150 is in a form of a disc. It is to be understood that this is merely illustrative and the support platform 150 may be of any other proper forms. In some embodiments, the support platform 150 may be omitted and the chassis 110 can serves as a platform for supporting the articles. In some embodiments, the support platform 150 may be implemented as a lift platform which is beneficial in facilitating charging or discharging articles. Since these components are not essential part of the invention, their detailed description is omitted so as to not obscure the concept of the invention.

Wheels are provided for moving the vehicle. One or more suspension devices are provided to connect the chassis 110 to the wheels and allow a relative motion between the chassis 110 and the wheels. With the suspension devices, the loads of the total weight of the chassis itself as well as the articles thereon are transmitted to the ground via the suspension devices. Since the suspension devices allow a relative motion between the chassis 110 and the wheels, vibrations of the chassis caused by uneven ground surfaces can be mitigated.

In the shown embodiment, as shown in FIGS. 1-3, three suspension devices 120, 130, 140 are provided. In particular, as shown in FIGS. 2 and 3, the suspension devices 120 and 140 are arranged on the respective lateral sides of the vehicle. The lateral side is corresponding to a direction perpendicular to the moving direction of the vehicle. In FIG. 3, the later side direction is the upper-lower direction of the paper and the forward-backward direction is the left-right direction of the paper. The suspension devices 120 and 140 each include one or more driving wheel. The driving wheel can be driven by an actuator such as electrical actuator fixed on the chassis. By operation of the actuator, the driving wheel can rotate to drive the whole vehicle forward or backward. The two suspension devices 120 and 140 may be connected by a differential gear assembly (not shown). When the driving wheels of the two suspension devices 120 and 140 rotate at different speeds, the vehicle is allowed to turn or move laterally by the differential gear assembly. A suspension device 130 may be provided at a backward side of the chassis 110.

In the shown embodiment, the suspension device 130 includes one or more driven wheels. When the driving wheel moves, the driven wheel moves accordingly. In the shown embodiment, there are three suspension devices 120, 130, 140, and two suspension devices 120, 140 each include a driving wheel while one suspension devices 130 includes two driven wheels. It is to be understood that this is merely illustrative and the number of the suspension devices may other numeral values and the wheel forms may be of any other proper forms as long as the vehicle can be stably driven. For example, in some embodiments, only two suspension devices 120, 140 are provided and the suspension device 130 can be omitted. In other embodiments, four suspension devices 120, 140 may be provided, with two suspension devices arranged at the lateral sides with one on a forward side and one on a backward side.

The suspension devices may adopt various forms. In the shown embodiment, the suspension devices 120, 130, 140 each are in form of a hinged suspension device which allows the suspension device to move upward or downward with respect to the chassis. In the shown embodiment, all the three suspension devices 120, 130, 140 take analogous hinged configuration. It is to be understood that this is merely illustrative and the suspension devices may be different from each other. For example, in one example, one or more suspension devices are hinged suspension device while others may be a suspension device using other flexible supporting means, such as springs, air spring, and so on.

As shown in FIGS. 1-3, the suspension device 120 includes a wheel 124, a wheel 126, a support bracket 128 connecting the wheel 124 and the wheel 126, and a hinge shaft 121 configured to connect the support bracket 128 to the chassis 110. The wheel 124 is a driving wheel which can be actuated by an electronical actuator 122. The wheel 126 is a caster wheel. The wheel 126 not only balances the weight distribution of the vehicle but also facilitates travelling of the vehicle. The stability of the vehicle can be improved. When the driving wheel 124 rotates, the wheel 126 rotates accordingly. The chassis 110 may include one or more mounting portions 112 integrated with the body 114. At the mounting portions 112, the support bracket 128 is hinged to the chassis 110. As shown in FIG. 3, a groove 117 may be provided on a bottom surface of the body 114. The support bracket 128 may be received in the groove 117. In some embodiments, when the support bracket 128 is received in the groove, a bottom end of the support bracket 128 does not protrude beyond the bottom surface of the body 114. In this way, the overall height of chassis can be maximized.

As shown in FIG. 2, the mounting portions 112 may protrude from the body 114. The support bracket 128 may be fixed to the protruding part of the mounting portions 112. In some embodiments, a hole may be provided in the mounting portion 112. A further hole may be provided in the support bracket 128. The hinge shaft 121 may extend through the hole in the mounting portion 112 and the further hole in the support bracket 128 to hingedly connect the mounting portion 112 of the chassis to the support bracket 128. When the vehicle travels on an uneven surface, the wheel 124 and the wheel 126 are at different levels, the hinged connection allows relative movement between the chassis 110 and the wheels 124, 126. In some embodiments, some anti-vibration means may be arranged between the support bracket 128 and the chassis 110 at the mounting portion 112, and/or between the hinge shaft and the chassis. It is to be understood that the shown hinged arrangement is merely illustrative and the suspension device may be implemented in any other proper forms.

In the shown embodiment, the suspension device 140 and the suspension device 120 are symmetrically arranged with respect to forward-backward direction of the vehicle. The suspension device 140 has substantially the same configuration. In particular, as shown in FIGS. 2 and 3, the suspension device 140 includes a wheel 144, a wheel 146, a support bracket 148 connecting the wheel 144 and the wheel 146, and a hinge shaft 141 configured to connect the support bracket 148 to the chassis 110. The wheel 144 is a driving wheel which can be actuated by an electronical actuator 142. The wheel 146 is a caster wheel. When the driving wheel 144 rotates, the wheel 146 rotates accordingly and the vehicle thus travels steadily.

In the shown embodiment, the suspension device 130 has substantially the same configuration and is arranged at the backward side of the chassis. The suspension device 130 is substantially the same as the suspension devices 120, 140. The suspension device 130 includes a wheel 134, a wheel 136, a support bracket 138 connecting the wheel 134 and the wheel 136, and a hinge shaft 131 configured to connect the support bracket 138 to the chassis 110. Different from the driving wheels of the suspension devices 120, 140, the wheels 134, 136 in the suspension devices 130 are caster wheel. The wheels 134, 136 not only balance the weight distribution of the vehicle but also facilitate travelling of the vehicle. The stability of the vehicle can be further improved. When the driving wheels 124, 144 rotate, the wheels 134, 136 rotate accordingly. The vehicle thus travels steadily.

According to the present disclosure, a sensor is provided on the hinge shaft. The sensor is configured to detect a force transmitted from the chassis 110 to the support bracket. When the vehicle runs on the ground surface, the overall weight of the whole chassis as well as the weight of loads thereon is applied on the hinge shaft and is in turn transmitted to the support bracket and then to the wheels contacting the ground surface. When the sensor is arranged at the hinge shaft between the chassis and the wheels, the sensor can detect the force that is borne by the hinge shaft. The force includes not only the weight of chassis itself but also the weight of loads thereon. When measurement data from this sensor is used to driving control of the vehicle, the gravity center of the overall vehicle (in particular, a change of the gravity center) can be determined with improved precision compared with the conventional method.

In some embodiments, every hinge shaft is provided with one or more sensors. The sensors can obtain the weight distribution across the chassis. In the shown example, as shown in FIG. 3, a triangle illustrated by dashed lines shows the spatial arrangement of the hinge shaft. Measurement data from the sensors on the hinge shafts can represent the weight distribution across the chassis during travelling of the vehicle. Instructions that are used to control operations of the vehicle can be directly determined based on the measurement data so as to prevent tipping of the vehicle. These instructions, for example, include stopping the vehicle or reducing travelling speed by controlling the actuators. It is to be understood that the shown triangle pattern is merely illustrative and the arrangement pattern of the sensors may be of any other proper forms.

Various methods may be used to generate the above instructions based on the measurement data. In one embodiment, the gravity center of the overall vehicle can be determined based on the measurement data. The determined gravity center may be compared with a gravity center when the vehicle is steady on a plat surface. A change of the current gravity center is thus determined. When a change of the gravity center exceeds a predetermined threshold value, the instructions for operating the actuators can be generated. The predetermined threshold value may be determined in advance. When the change of the gravity center is below the predetermined threshold value, this means that there is no risk of tipping while when the change of the gravity center exceeds the predetermined threshold value, this means that there is risk of tipping. When there is a risk of tipping, the vehicle should be decelerated or stopped to avoid overturning of the vehicle.

In some embodiment, the instructions may be generated by determining whether the determined gravity center is located in a predetermined region. This predetermined region may be determined according to the spatial arrangement of the sensors. When the gravity center is located in a predetermined region, it means that there is no risk of tipping. In the shown embodiment, as shown in FIG. 3, the triangle illustrated by dashed lines may represent the predetermined region since a plane determined by three points may represent a stable plane. When the determined gravity center is located within the triangle, there is no risk of tipping and there thus is no need to decelerate or stop the vehicle. When the determined gravity center is outside the triangle, there is high possibility that the vehicle overturns and the vehicle should be decelerated or stopped.

In some embodiments, instead of using all measurement data from the sensors, partial measurement data may be used to generate the instructions. For example, when the weight on the chassis is not centrally located, this means that the weight is not uniformly distributed on the wheels. For example, some wheels do not contact the ground surface or contact the ground surface with a small force while some wheels are overloaded. Thus, the measurement force parameters from some sensors on some hinge shafts is zero or small while the measurement force parameters from some sensors on some hinge shafts are overwhelming large. In this event, if the vehicle travels at a high speed, there is a high possibility that the vehicle would overturn. Thus, the instructions can be determined based on the predetermined logic based on an oversmall force value from one or more sensors, an overlarge force value from one or more sensors, or their combination.

The sensor may be of various types. For example, the sensor may be a load cell, a strain gauge, a piezoelectric sensor, or any other proper forms as long as the sensor can detect the force from the chassis 110. In some embodiments, each hinge shaft of the suspension device is provided with a sensor. In other embodiments, partial hinge shafts of the suspension device are provided with sensors while other hinge shafts of the suspension device are not equipped with a sensor.

There are many manners for providing the sensor on the hinge shaft. In some embodiments, the sensor may be fixed on the hinge shaft via various mechanical means, for example, fasteners, adhesives, snap-fit device and the like. The mechanical means may be of various forms as long as long the sensor can be attached to the hinge shaft. In some applications, there is no space for mounting the sensor onto the hinge shaft, or there is no standard means for fixing the sensor onto the hinge shaft. According to the present disclosure, the sensor may be integrated in the hinge shaft. That is, the hinge shaft itself implement two functions, one being used as a load bearing member to transmit forces from the chassis to the wheels, the other being a sensor for detecting, for example a shear force transmitted from the chassis to the support bracket. The sensor in form of a shaft not only obviates the need to attach the sensor onto the shaft but also improve compactness and reliability of the vehicle. Also, there is beneficial in terms of manufacturing of the vehicle since provision of the sensor does not incur additional assembly efforts.

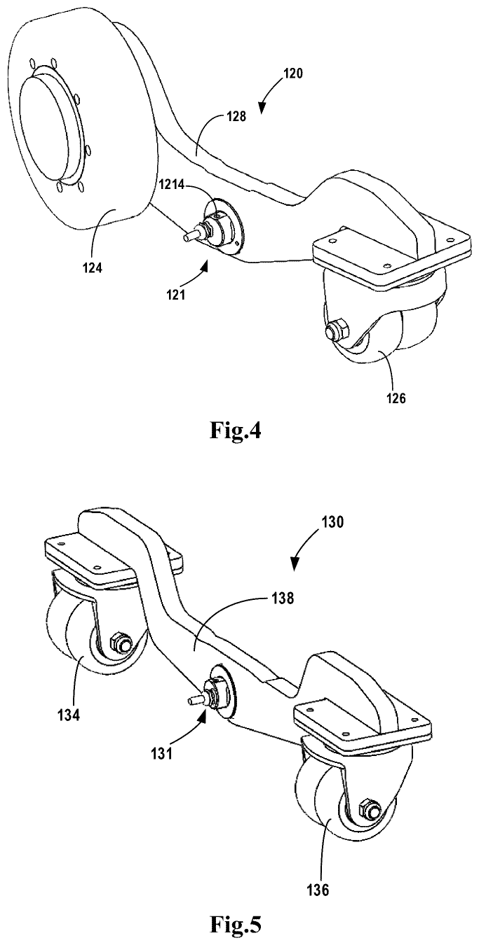

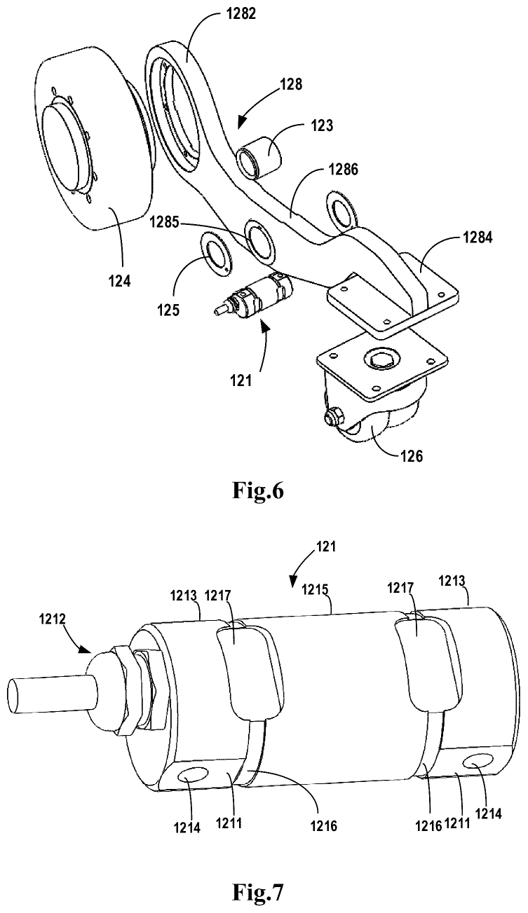

FIGS. 4 and 5 show perspective views of suspension devices according to one example embodiment of the present disclosure respectively. The suspension device 120 in FIG. 4 is substantially the same as the suspension device 130 in FIG. 5. The main difference is that the suspension device 120 in FIG. 4 includes a driving wheel 124 and a driven wheel 126 while the suspension device 130 in FIG. 5 includes two driven wheels 134, 136. Since the suspension device 120 is substantially the same as the suspension device 130, for sake of conciseness, taking the suspension device 120 as an example, the detailed structure of the suspension device is illustrated as below with reference to FIGS. 6-8.

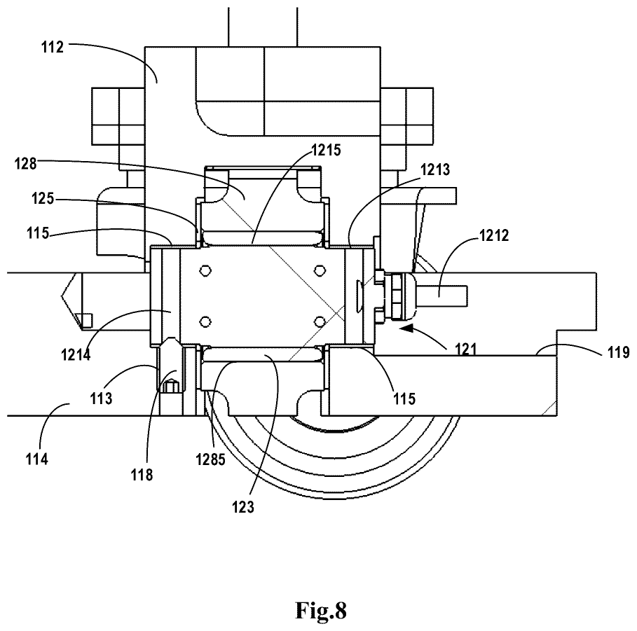

FIG. 6 is an exploded view of the suspension device of FIG. 4, FIG. 7 is a perspective view of a hinge shaft, and FIG. 8 is a partial section view through a mounting portion 112 according to one example embodiment of the present disclosure.

As shown in FIGS. 4 and 6, the suspension device 120 includes a driving wheel 124 and a driven wheel 126. A support bracket 128 is provided to connect the first wheel 124 and the second wheel 126. With the support bracket 128, the driven wheel 126 can run as the driving wheel 124 rotates. A hinge shaft 121 is provided and is configured to connect the support bracket 128 to the chassis 110. The hinge shaft 121 is not only used as force transmitting member but also a sensor for detecting a shear force.

The support bracket 128 may be of various forms. In some embodiments, as shown in FIG. 6, the support bracket 128 may include a first end section 1282, a second end section 1284, and an intermediate section 1286. The first end section 1282 is configured to receive the driving wheel 124. The second end section 1284 is opposite to the first end section 1282 and is configured to receive the driven wheel 126. The intermediate section 1286 is located between the first end section 1282 and the second end section 1284 and is configured to receive the hinge shaft 121. It is to be understood that the shown support bracket 128 is merely illustrative and the support bracket 128 may be of any other proper forms.

The hinge shaft 121 may be of various forms. In some embodiments, as shown in FIG. 7, the hinge shaft 121 is in form of a shaft. The hinge shaft 121 is a load bearing member and is thus designed with sufficient strength to bear loads. The hinge shaft 121 may include a first stem portion 1213 and a second stem portion 1215 extending in an axial direction of the hinge shaft 121. The first stem portion 1213 is configured to contact the chassis 110. The second stem portion 1215 is configured to contact the support bracket 128. The shaft is also provided with recesses 1217 for receiving sensing elements, for example, strain gauges. Communication cables for outputting signals from the sensing elements may be internally arranged within the shaft. The shaft may be provided with inner paths for receiving communication cables. A wiring interface 1212 may be arranged on one axial end of the hinge shaft 121. Signals from the sensing elements can be output via the wiring interface 1212. This is beneficial since the one axial end of the hinge shaft 121 can be easily accessed by the user. It is to be understood that the shown hinge shaft 121 is merely illustrative and the hinge shaft 121 may be of any other proper forms.

In some embodiments, as shown in FIG. 7, the hinge shaft 121 is prevented from lateral movement in the axial direction of the hinge shaft 121. In some embodiments, as shown in FIG. 7, a location hole 1214 may be provided. The location hole 1214 may extend in a direction perpendicular to an axial direction of the hinge shaft 121. As shown in FIG. 8, a member 118 can be inserted into the location hole 1214 to prevent lateral movement of the hinge shaft 121 in the axial direction of the hinge shaft 121. In some embodiment, a through hole 113 may be provided in a bottom side of the chassis 110. The member 118 may engage with the through hole 113 and is at least partially received in the location hole 1214. The member 118 may be of various forms. In some embodiments, the member 118 may be a screw, a pin, and the like. With this arrangement, the hinge shaft 121 can be fixed in position on the chassis 110. Alternatively, the member 118 may be a protrusion part of the chassis. It is to be understood that the location hole 1214 is merely illustrative and other means may be used to realize the above function.

In some embodiments, as shown in FIG. 7, a flat surface 1211 is provided at a position where the location hole 1214 is provided. With the flat surface, a surface contact between the hinge shaft 121 and the chassis 110 can be realized.

In some embodiments, the hinge shaft 121 (also called the shaft sensor) may be configured to detect a shear force. In many applications, in order ensure that the sensing elements work properly, the shaft sensor should be located in a predetermined orientation such that the sensing members in the shaft can detect with high precision. In some embodiments, an anti-rotation means is provided to prevent he hinge shaft 121 from rotating. In some embodiments, the above mentioned location holes 1214 may also be used as anti-rotation means since the engagement between the member 118 and the hole 1214 can also prevent the hinge shaft 121 from rotaing. It is to be understood that this is merely illustrative and an additional member may also be provided to realize this function.

In some embodiments, as shown in FIGS. 6 and 8, the suspension device 120 may further include a bushing 123 sandwiched between an inner wall of the through hole 1285 and an outer surface of the hinge shaft 121. With the busing, friction between the hinge shaft 121 and the mounting portion 112 at the lateral surface of the shaft can be reduced and the lateral surface of the hinge shaft 121 can be protected to extend its lifespan. In some embodiments, as shown in FIGS. 6 and 8, the suspension device 120 may further include a spacer 125 arranged around the hinge shaft 121 and sandwiched between a lateral side surface of the chassis 110 and a lateral side surface of the support bracket 128. With the spacer, friction between the hinge shaft 121 and the mounting portion 112 at the axial end surface of the shaft can be reduced and the axial end surface of the hinge shaft 121 can be protected to extend its lifespan. In some embodiments, as shown in FIG. 7, the hinge shaft 121 includes a circumferential groove 1216 configured to receive the spacer 125. By provision of the circumferential groove 1216, the spacer can be properly located.

FIG. 8 shows the assembly view showing details of the hinge shaft 121 and the mounting portion 112. A groove 119 may be provided on a top surface of the body 114 of the chassis 110 (also referring to FIG. 2). Via the groove 119, the hinge shaft 121 can be easily removed from the chassis. A second groove may be provided in the body 114 adjacent to the groove 119 for axially receiving the hinge shaft 121. A step portion may be formed between the groove 119 and the second groove. As shown in FIG. 8, on end of the second groove may engage with a axial end surface of the hinge shaft 121 so as to accommodate the hinge shaft 121 within the second groove.

As shown in FIG. 8 (also referring to FIG. 6), a through hole 1285 axially penetrates through the hinge shaft 121. One or more through holes 115 are provided on the mounting portion 112 of the chassis 110. The mounting portion 112 is one integral part of the chassis 110. In the shown embodiment, the mounting portion 112 is a U-shaped member and two arms of the U-shaped member sandwich the support bracket 128 therebetween. There are two through holes 115 located at a respective lateral side arm of the U-shaped member. The hinge shaft 121 extends through holes 115 and the through hole 1285 to connect the hinge shaft 121 and the support bracket 128. A size of the through hole 115 can be properly designed such that a movement magnitude of the hinge shaft 121 with respect to the chassis 110 can be ensured. It is to be understood that the shown mounting portion 112 is merely illustrative and the mounting portion may be of any other proper forms.

As shown in FIG. 8, a bushing 123 is sandwiched between an inner wall of the through hole 1285 and an outer surface of the hinge shaft 121. Two spacers 125 are arranged around the hinge shaft 121 and sandwiched between a lateral side surface of the chassis 110 and a lateral side surface of the support bracket 128 respectively. With these arrangements, contacts between the support bracket 128 and the chassis 110 can be improved. This is beneficial in reducing manufacturing tolerances of the components and in extending lifespan of the hinge shaft 121. Also as shown in FIG. 8, a through hole 113 may be provided in a bottom side of the chassis 110. The member 118 is arranged to extend through the through hole 113 and is at least partially received in the location hole 1214 of the shaft 121. With this arrangement, the hinge shaft 121 can be fixed in position with a predetermined orientation and is prevented from rotating. The wiring interface 1212 is arranged at one axial end of the hinge shaft 121. Signals from the sensor can be output via the wiring interface 1212.

A system for driving an unmanned transport vehicle is also provided. The system include a hinge shaft configured to connect a support bracket supporting a wheel to a chassis and comprising a sensor configured to detect a force transmitted from the chassis to the support bracket, and a controller configured to communicate with the sensor and to control a electronical actuator for driving a driving wheel based on the detected force. With the system, the controller can control the driving wheel in real time so as to prevent the vehicle from overturning.

According to the present disclosure, the sensor is arranged at a hinge shaft of a suspense device. The sensor can detect the overall weight of the vehicle including the payload and a weight of the vehicle itself. Thus, a gravity change of the vehicle can be determined with high precision. In some embodiments, the sensor is integrated in the hinge shaft. The sensor arrangement does not increase the overall height of the chassis. Moreover, the hinge shaft can be easily mounted and detached. Performances of the vehicle are improved in a cost effective way.

Through the teachings provided herein in the above description and relevant drawings, many modifications and other embodiments of the disclosure given herein will be appreciated by those skilled in the art to which the disclosure pertains. Therefore, it is understood that the embodiments of the disclosure are not limited to the specific embodiments of the disclosure, and the modifications and other embodiments are intended to fall within the scope of the disclosure. In addition, while exemplary embodiments have been described in the above description and relevant drawings in the context of some illustrative combinations of components and/or functions, it should be realized that different combinations of components and/or functions can be provided in alternative embodiments without departing from the scope of the disclosure. In this regard, for example, it is anticipated that other combinations of components and/or functions that are different from the above definitely described will also fall within the scope of the disclosure. While specific terms are used herein, they are only used in a general and descriptive sense rather than limiting.

1. An unmanned transport vehicle comprising:
a chassis and
a suspension device configured to connect the chassis to a wheel and allow a relative motion between the chassis and the wheel, the suspension device comprising:
a first wheel
a second wheel
a support bracket connecting the first wheel and the second wheel and
a hinge shaft configured to connect the support bracket to the chassis, wherein a first sensor is provided on the hinge shaft to detect a force transmitted from the chassis to the support bracket

2. The unmanned transport vehicle according to claim 1, wherein the first sensor is integrated in the hinge shaft

3. The unmanned transport vehicle according to claim 1, wherein the hinge shaft is kept in a predetermined orientation with respect to the chassis and the support bracket

4. The unmanned transport vehicle according to claim 1, wherein the hinge shaft comprises:
a first stem portion
a second stem portion extending in an axial direction of the hinge shaft and
a wiring interface arranged on one axial end of the hinge shaft

5. The unmanned transport vehicle according to claim 1, wherein the hinge shaft comprises a location hole extending in a direction perpendicular to an axial direction of the hinge shaft and configured to receive a member or a protrusion of the chassis to lock the hinge shaft in place.

6. The unmanned transport vehicle according to claim 1, wherein the support bracket comprises:
a first end section configured to receive the first wheel
a second end section opposite to the first end section and configured to receive the second wheel and
an intermediate section configured to connect the first end section and the second end section the intermediate section comprising a through hole for insertion of the hinge shaft

7. The unmanned transport vehicle according to claim 6, wherein the suspension device further comprises a bushing sandwiched between an inner wall of the through hole and an outer surface of the hinge shaft

8. The unmanned transport vehicle according to claim 6, wherein the suspension device further comprises a spacer arranged around the hinge shaft and sandwiched between a lateral side surface of the chassis and a lateral side surface of the support bracket.

9. The unmanned transport vehicle according to claim 8, wherein the hinge shaft further comprises a circumferential groove configured to receive the spacer

10. The unmanned transport vehicle according to claim 1, wherein the first wheel is a driving wheel actuated by an electronical actuator and the second wheel is a caster wheel.

11. The unmanned transport vehicle according to claim 1, wherein both the first wheel and the second wheel are caster wheels.

12. The unmanned transport vehicle according to claim 1, further comprising:
a second suspension device laterally arranged side by side with respect to the suspension device, the second suspension device comprising:
a third wheel
a fourth wheel
a second support bracket connecting the third wheel and the fourth wheel and
a second hinge shaft configured to connect the second support bracket to the chassis wherein a second sensor is provided on the second hinge shaft to detect a force transmitted from the chassis to the second support bracket

13. The unmanned transport vehicle according to claim 1, further comprising:
a third suspension device arranged at a front side or a back side with respect to the suspension device in a travel direction of the unmanned transport vehicle the third suspension device comprising:
a fifth wheel and a sixth wheel;
a third support bracket connecting the fifth wheel and the sixth wheel; and
a third hinge shaft configured to connect the third support bracket to the chassis wherein a third sensor is provided on the third hinge shaft to detect a force transmitted from the chassis to the third support bracket

14. A system for driving an unmanned transport vehicle comprising:
a hinge shaft configured to connect a support bracket supporting a wheel to a chassis and comprising a sensor configured to detect a force transmitted from the chassis to the support bracket; and
a controller configured to communicate with the sensor and to control an electronical actuator for driving a driving wheel based on the detected force.
